(19) United States
(12) Patent Application Publication
(10) Pub. No.: US 2014/0192189 A1
(43) Pub. Date: Jul. 10, 2014

(54) AUTOMATIC SENSING LAMP CAPABLE OF NETWORK TRANSMISSION AND LONG-DISTANCE SURVEILLANCE/REMOTE-CONTROL AUDIO-VIDEO OPERATIONS

(71) Applicant: Chin Mu Hsieh, Tainan City (TW)

(72) Inventor: Chin Mu Hsieh, Tainan City (TW)

(21) Appl. No.: 13/735,888

(22) Filed: Jan. 7, 2013

(51) Int. Cl. H04N 7/18

(52) U.S. Cl. CPC H04N 7/18
USPC 348/143

(57) ABSTRACT

An automatic sensing lamp capable of network transmission and long-distance surveillance/remote-control audio-video operations is provided for use with a computer or mobile phone. A network connector or wireless transceiver unit of an image-processing IC of the sensing lamp is connected via the Internet to a connection port of a long-distance surveillance/remote-control computer or to a mobile phone. After a software driver is activated, a username and a password built in the image-processing IC are input. When an image-sensing camera unit detects movement of a target, a light-emitting device emits light and a loudspeaker generates sounds to produce a warning and intimidating effect. Images and sounds currently taken by the image-sensing camera unit are transmitted by the image-processing IC to the computer or mobile phone for displaying and playing. The image-sensing camera unit and the light-emitting device can be turned by remote control by the computer or mobile phone.

### BACKGROUND OF THE INVENTION

1. Technical Field

The present invention relates to an automatic sensing lamp capable of network transmission and long-distance surveillance/remote-control audio-video operations. More particularly, the present invention relates to a sensing lamp in which a network connector or wireless transceiver unit of an image-processing integrated circuit (IC) is connected to the Internet so that not only can images and sounds taken be transmitted by the image-processing IC to a remote computer or mobile phone for displaying and playing, but also an image-sensing camera unit and a light-emitting device can be turned by remote control by the remote computer or mobile phone.

2. Description of Related Art

Thanks to technological advancements, people nowadays can monitor the conditions of places other than where they are with long-distance surveillance devices.

Take access control systems for example. Existing access control systems work in various ways. One conventional access control system is designed to be activated passively by a visitor. For instance, the access control system is driven to operate (e.g., serving as a long-distance communication tool between the property owner and a visitor or recording the visitor's images) when the visitor presses an intercom button.

Another existing form of long-distance surveillance devices is the well-known surveillance cameras widely used on the streets and in apartment buildings. A surveillance camera is configured for rerecording images continuously for a long period of time, and the images recorded can be viewed later when needed.

Also commercially available is a warning system which turns on a lighting device, and thereby produces a warning or intimidating effect, as soon as an object approaches an access control system. This warning system, however, provides only warning but not access control.

Although the aforementioned surveillance devices are capable of monitoring the conditions of remote areas and recording images for later reference, those who use such surveillance devices at home cannot be informed of the indoor or outdoor conditions of their homes when they are abroad or on a business trip, i.e., far away from the surveillance devices.

### BRIEF SUMMARY OF THE INVENTION

In view of the above, the present invention provides an automatic sensing lamp capable of network transmission and long-distance surveillance/remote-control audio-video operations as disclosed herein. The present invention is intended to solve the problem that the prior art devices do not allow images and sounds taken by a camera to be displayed and played at a remote location.

The disclosed automatic sensing lamp capable of network transmission and long-distance surveillance/remote-control audio-video operations includes at least one image-sensing camera unit, a light-emitting device, an image-processing integrated circuit (IC), and a memory.

The at least one image-sensing camera unit is provided with a sensing area having at least one section, and an adjustment button. The light-emitting device is connected to the image-sensing camera unit. The image-processing IC is connected to the image-sensing camera unit and has a network connector and a wireless transceiver unit. The image-processing IC is also built-in with a username and a password. The memory is connected to the image-processing IC.

The sensing lamp is configured for use with a computer.

The computer includes a hard disk drive, a screen, and at least one connection port. The hard disk drive stores a software driver therein.

The sensing lamp is configured for use with a mobile phone.

The mobile phone includes a screen and a storage space, wherein the storage space stores a software driver therein.

The sensing lamp further includes a loudspeaker.

The adjustment button enables adjustment in illuminance, in the light activation time, and in sensing sensitivity.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a block diagram of the present invention;

FIG. 2 is a block diagram showing the present invention connected with a computer and a mobile phone;

FIG. 3 is a perspective view of the present invention connected with a computer and a mobile phone;

FIG. 4 is a perspective view of the present invention connected with a computer; and

FIG. 5 is a perspective view of the present invention connected with a mobile phone.

### DETAILED DESCRIPTION OF THE INVENTION

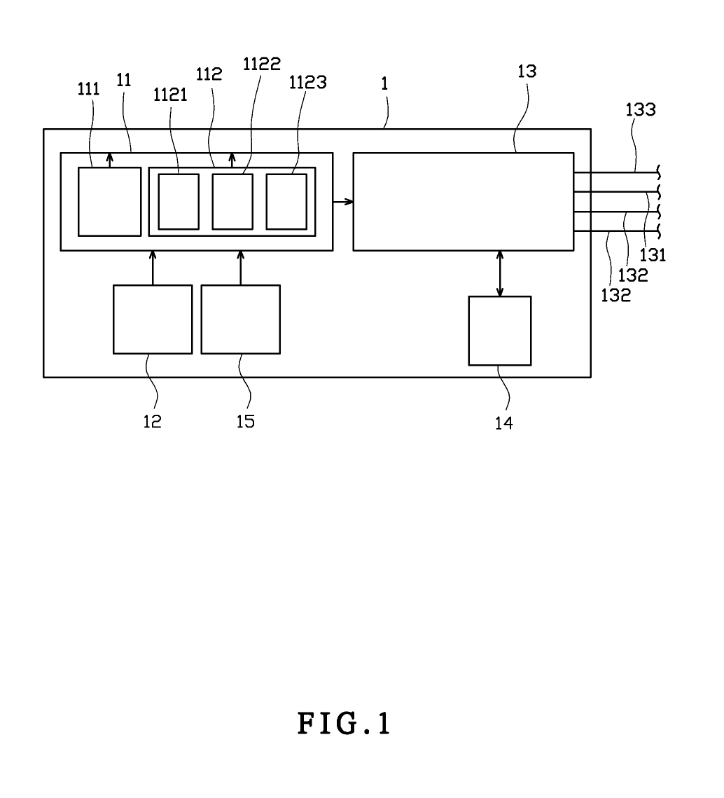

Referring to FIG. 1, an automatic sensing lamp 1 capable of network transmission and long-distance surveillance/remote-control audio-video operations includes at least one image-sensing camera unit 11, a light-emitting device 12, an image-processing IC 13, a memory 14, and a loudspeaker 15.

The at least one image-sensing camera unit 11 has a 360° (0°˜360°) sensing area 111 and an adjustment button 112. The adjustment button 112 includes a button 1121 for adjusting illuminance, a button 1122 for adjusting the light activation time, and a button 1123 for adjusting sensing sensitivity. More specifically, the button 1121 for adjusting illuminance (with the symbol “LUX”) allows the activation point of the image-sensing camera unit 11 to be adjusted, wherein the activation point is related to a change in ambient lighting from brightness to darkness or vice versa; the button 1122 for adjusting the light activation time (with the symbol “TIME”) allows the time period during which light is turned on to be adjusted; and the button 1123 for adjusting sensing sensitivity (with the symbol “SENSI”) allows the range of sensitivity of the sensing area 111 to be adjusted.

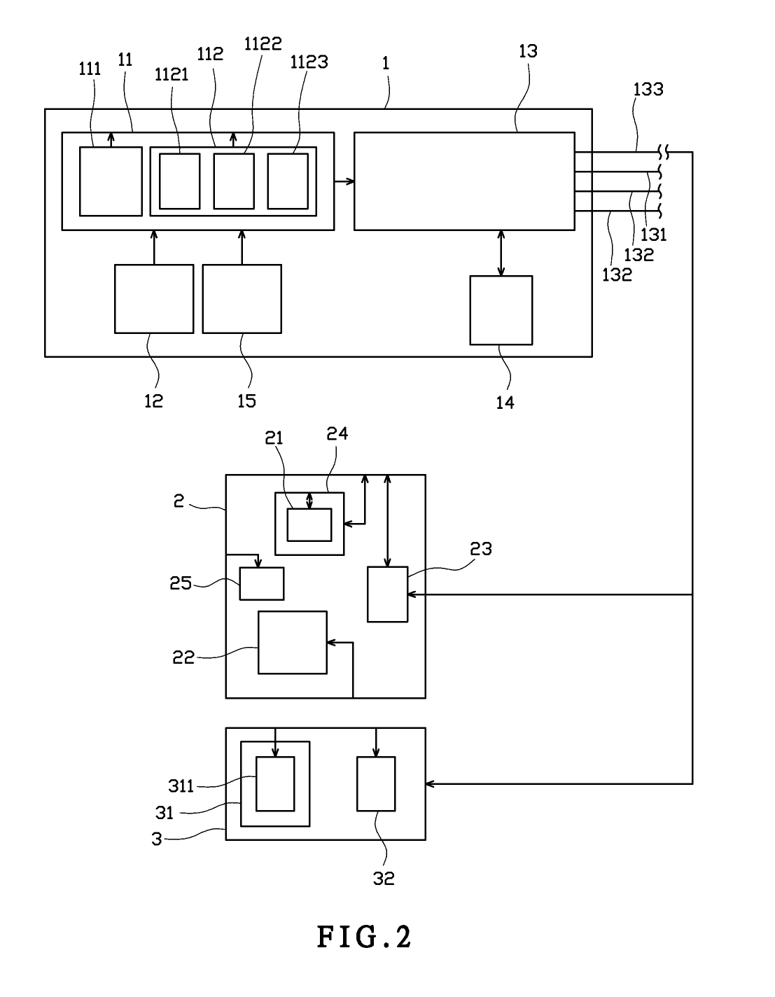

The light-emitting device 12 is connected to the at least one image-sensing camera unit 11 and is configured to follow the target (e.g., a person or object) detected by the at least one image-sensing camera unit 11 within the sensing area 111 while the images and sounds taken by the at least one image-sensing camera unit 11 are transmitted to a computer 2 and a mobile phone 3 (see FIG. 2). In other words, the light-emitting device 12 can track and illuminate the target (e.g., a person or object) being detected. The light-emitting device 12 may be fixedly connected to the at least one image-sensing camera unit 11.

The image-processing IC 13 (e.g., a digital still camera; DSC) is connected to the at least one image-sensing camera unit 11. In addition, the image-processing IC 13 is connected with a network connector 131 (e.g., an RJ-45), at least one computer connector 132 (e.g., an RS-232 or RS-485), and a wireless (e.g., WiFi) transceiver unit 133. Through the network connector 131 and the wireless (e.g., WiFi) transceiver unit 133, the image-processing IC 13 can transmit audio-video signals to the Internet. Moreover the image-processing IC 13 is built-in with a username and a password.

The memory 14 is connected to the image-processing IC 13 and has the operation mode options OFF, AUTO, and ON for turning off the audio-video recording function of the memory 14, for operating under the control of the at least one image-sensing camera unit 11, and for operating continuously without being controlled by the at least one image-sensing camera unit 11, respectively. Thus, in addition to providing storage, the memory 14 allows a recording time to be set in advance.

The loudspeaker 15 is connected to the at least one image-sensing camera unit 11. When the at least one image-sensing camera unit 11 detects a movement, the loudspeaker 15 generates a warning sound to produce a warning and intimidating effect.

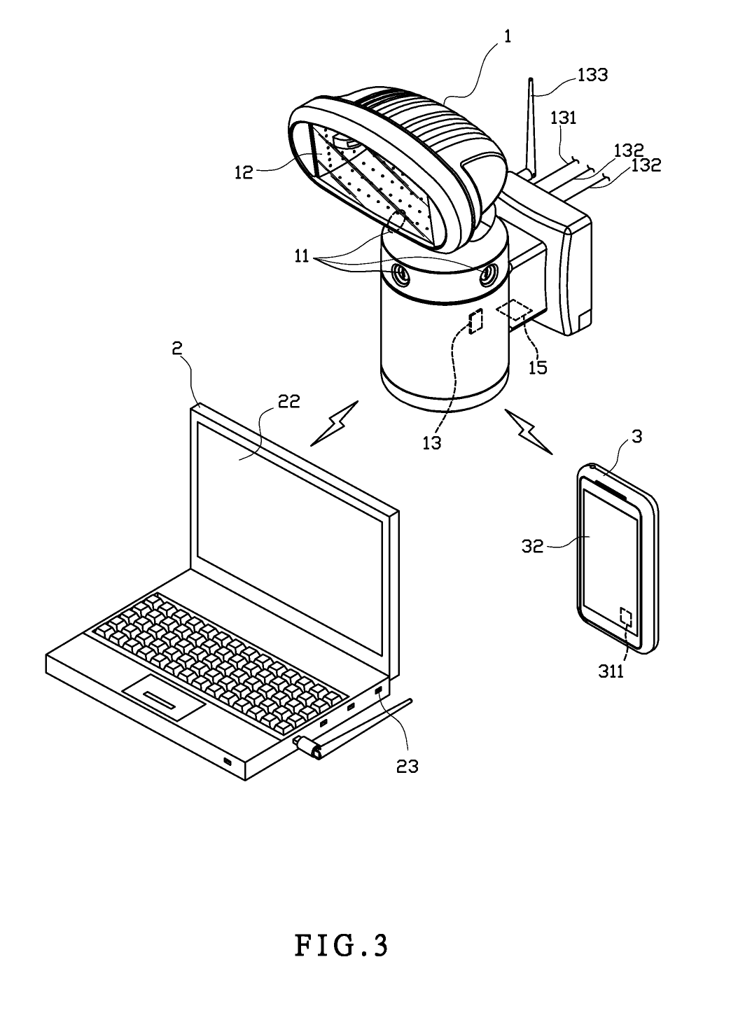

The sensing lamp 1 is configured for use with a computer 2 or a mobile phone 3 (3G/4G) (see FIG. 2 and FIG. 3). The computer 2 is provided with a hard disk drive 21, a screen 22, and a connection port 23, wherein the connection port 23 may be a USB (Universal Serial Bus) connection port. The hard disk drive 21 stores a software driver 24 therein. The computer 2 also has a loudspeaker 25. When detecting a movement, the computer 2 generates a “beep” sound as an alert.

The mobile phone 3 is provided with a storage space 31 and a screen 32. The storage space 31 stores a software driver 311 therein.

In use, referring to FIG. 3 in conjunction with FIG. 2, the network connector 131 of the image-processing IC 13 of the sensing lamp 1 is connected to the Internet and is coupled through the Internet to the connection port 23 of the long-distance surveillance/remote-control computer 2 or to the mobile phone 3. Then, the software driver 24 is activated, and the username and password built in the image-processing IC 13 are input via the computer 2 or the mobile phone 3 to activate and automatically capture the internal time and date of the computer 2 or the mobile phone 3. Next, the adjustment button 112 of the image-sensing camera unit 11 is adjusted to adjust the setting of illuminance 1121, of the light activation time 1122, and of sensing sensitivity 1123. The desired operation mode of the memory 14 (e.g., AUTO as in the present embodiment) is also selected. Once the image-sensing camera unit 11 detects movement of a target (e.g., a person or object) within the sensing area 111, the light-emitting device 12 emits light and can turn along with the image-sensing camera unit 11 within the sensing area 111 to eliminate any dead corners in terms of image taking. Meanwhile, the loudspeaker 15 generates a warning sound for warning and intimidation, and the image-processing IC 13 sends out the audio-video signals of the target detected in the sensing area 111. It is understood that, with the sensing lamp 1 connected to the computer 2 and the mobile phone 3, the images currently taken by the image-sensing camera unit 11 can be viewed on the screen 22 of the computer 2 and the screen 32 of the mobile phone 3. Thus, long-distance surveillance/remote-control audio-video operations are achieved, thanks to network transmission.

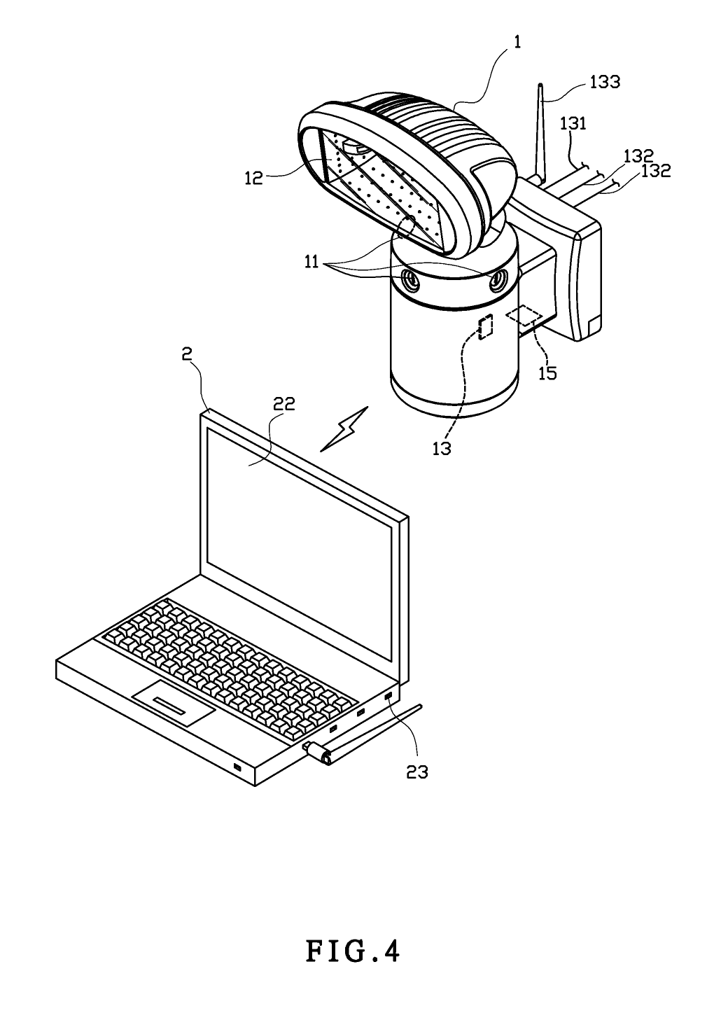

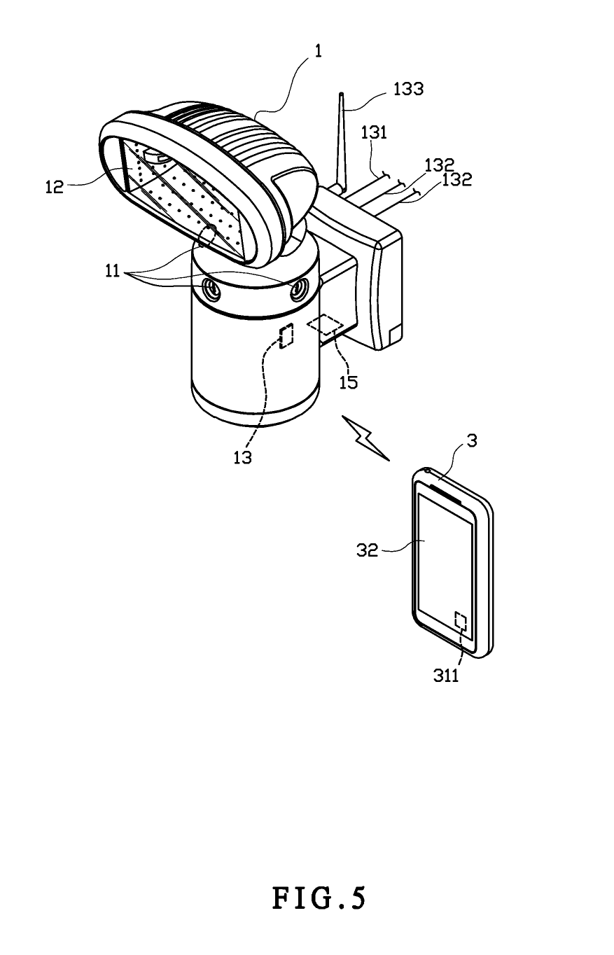

To facilitate product testing before shipment, the computer connector 132 and the wireless (e.g., WiFi) transceiver unit 133 of the image-processing IC 13 of the sensing lamp 1 can also be connected directly to the connection port 23 of the computer 2 (see FIG. 4) or be connected to the mobile phone 3 through the Internet (see FIG. 5) so that the built-in username and password of the image-processing IC 13 can be input via the computer 2 or the mobile phone 3.

What is claimed is:

1. An automatic sensing lamp capable of network transmission and long-distance surveillance/remote-control audio-video operations, comprising:
at least one image-sensing camera unit, the at least one image-sensing camera unit being provided with a sensing area and an adjustment button, wherein the sensing area has at least one section;
a light-emitting device connected to the at least one image-sensing camera unit;
an image-processing integrated circuit (IC) connected to the at least one image-sensing camera unit, the image-processing IC having a network connector and a wireless transceiver unit, the image-processing IC being built-in with a username and a password; and
a memory connected to the image-processing IC.

2. The automatic sensing lamp of claim 1, wherein the sensing lamp is configured for use with a computer.

3. The automatic sensing lamp of claim 2, wherein the computer comprises a hard disk drive, a screen, and at least one connection port, the hard disk drive storing a software driver therein.

4. The automatic sensing lamp of claim 1, wherein the sensing lamp is configured for use with a mobile phone.

5. The automatic sensing lamp of claim 4, wherein the mobile phone comprises a storage space and a screen, the storage space storing a software driver therein.

6. The automatic sensing lamp of claim 1, wherein the sensing lamp further comprises a loudspeaker.

7. The automatic sensing lamp of claim 1, wherein the adjustment button enables adjustment in illuminance, in a light activation time, and in sensing sensitivity.
